(19) United States
(12) Patent Application Publication
(10) Pub. No.: US 2010/0292374 A1
(43) Pub. Date: Nov. 18, 2010

(54) CROSSLINKED POLYMERS AND METHODS OF MAKING THE SAME

(76) Inventor: Anuj Bellare, Brighton, MA (US)

Correspondence Address: FISH & RICHARDSON PC, P.O. BOX 1022, MINNEAPOLIS, MN, 55440-1022, US

(21) Appl. No.: 12/681,282

(22) PCT Filed: Aug. 20, 2008
(86) PCT No.: PCT/US08/73733

§ 371 Date: Aug. 2, 2010

Related U.S. Application Data
(60) Provisional application No. 60/977,970, filed on Oct. 5, 2007.

(51) Int. Cl. C08K 5/1545; C08F 110/02; C08L 23/06; C08K 5/13

(52) U.S. Cl. 524/110; 526/352; 524/587; 524/323

(57) ABSTRACT

Methods are described that include elongating, e.g., by stretching and/or compressing, a polymeric material, such as an ultra-high molecular weight polyolefin (e.g., an ultra-high molecular weight polyethylene (UHMWPE)), below, or above a melt temperature of the polymeric material to disentangle polymeric chains of the polymeric material. The disentangled materials provided can be effectively and efficiently crosslinked, e.g., by using ionizing radiation (e.g., generated by a gamma radiation source and/or an electron beam source). Parts formed from the crosslinked polymeric materials have, e.g., high wear resistance, enhanced stiffness, as reflected in flexural and tensile moduli, a high level of fatigue and crack propagation resistance, and enhanced creep resistance. Some of the crosslinked polymeric materials have a low coefficient of friction. Prior to elongating, it can be desirable to slightly crosslink the polymeric material to impart shape memory into the polymeric material.

### TECHNICAL FIELD

This invention relates to crosslinked materials, methods of making crosslinked materials, and to uses of the same.

### BACKGROUND

Polymeric materials are used in medical endoprostheses, e.g., orthopaedic implants (e.g., hip replacement prostheses). For example, ultrahigh molecular weight polyethylene (UHMWPE) is used to form components of artificial joints. Desirable characteristics for the polymeric materials used in medical endoprostheses include biocompatibility, a low coefficient of friction, a relatively high surface hardness, and resistance to wear and creep. It is also desirable for materials used in such endoprostheses to be readily sterilizable, e.g., by using high-energy radiation, or by utilizing a gaseous sterilant such as ethylene oxide, prior to implantation in a body, e.g., a human body.

High-energy radiation, e.g., in the form of gamma, x-ray, or electron beam radiation, is used to sterilize some endoprostheses, because in addition to sterilizing the endoprostheses, the high energy radiation can sometimes crosslink the polymeric materials, thereby improving the wear resistance. However, while treatment of some endoprostheses with high-energy radiation can be beneficial, high-energy radiation can also have deleterious effects on certain polymeric components. For example, treatment of polymeric components with high-energy radiation can result in the generation of long-lived, reactive species within the polymeric matrix, e.g., free radicals, radical cations, or reactive multiple bonds, that over time can react with oxygen, e.g., of the atmosphere or dissolved in biological fluids, to produce oxidative degradation of the polymeric materials.

Such degradation can reduce the wear resistance of the polymeric material. Therefore, it is often advantageous to reduce the number of such reactive species. Radiation sterilization of polymeric materials, crosslinking, and entrapment of long-lived, reactive species, and their relationship to wear, crack propagation, and other mechanical properties are discussed in Kurtz et al., Biomaterials, 20, 1659-1688 (1999); Tretinnikov et al., Polymer, 39(4), 6115-6120 (1998); Maxwell et al., Polymer, 37(15), 3293-3301(1996); Kurtz et al., Biomaterials, 27, 24-34 (2006); Wang et al., Tribology International, 31(1-3), 17-33 (1998); Oral et al., Biomaterials, 26, 6657-6663 (2005); Oral et al., Biomaterials, 25, 5515-5522 (2004); Muratoglu et al., Biomaterials, 20, 1463-1470 (1999); Hamilton et al., European Patent Application No. 1072276A1; Li et al., U.S. Pat. No. 5,037,928, NcNulty et al., U.S. Pat. No. 6,245,276; and Muratoglu et al., PCT Publication No. WO 2005/074619. Additional references include U.S. Pat. Nos. 5,414,049, 6,228,900, 6,547,828, 6,464,926, 6,641,617 and 6,786,933; Baker D A, Bellare A and Pruitt L, “The Effect of Degree of Crosslinking on the Fatigue Crack Propagation Resistance of Orthopedic-Grade Polyethylene,” Journal of Biomedical Materials Research (2003) 66A:146-154; Oral E, Wannomae K K, Hawkins N E, Harris W H, Muratoglu O K, “Alpha-Tocopherol Doped Irradiated UHMWPE for High Fatigue Resistance and Low Wear,” Biomaterials (2004) 25(24):5515-5522); and U.S. Published Patent Application Nos. 2005/0043431, 2003/0149125, and 2005/0194722.

### SUMMARY

This invention relates to crosslinked materials, methods of making crosslinked materials, and to uses of the same.

Generally, the methods described herein include elongating, e.g., by stretching and/or compressing, a polymeric material, such as an ultra-high molecular weight polyolefin (e.g., an ultra-high molecular weight polyethylene (UHMWPE)), below, at, or above a melt temperature of the polymeric material to disentangle polymeric chains of the polymeric material. The resulting disentangled materials provided can be effectively and efficiently crosslinked, e.g., by using ionizing radiation (e.g., generated by a gamma radiation source and/or an electron beam source). After crosslinking, the polymeric material is subjected to any one or more of various heat treatments described herein to effectively reduce the concentration of reactive species trapped in the polymeric material, such as free-radicals or radical cations, resulting in oxidation resistant materials. Thus, the methods provide materials that are stable over extended periods of time and that are resistant to oxidation. In addition, parts formed from the crosslinked polymeric materials have, e.g., high wear resistance, enhanced stiffness, as reflected in flexural and tensile moduli, a high level of fatigue and crack propagation resistance, and enhanced creep resistance. Some of the crosslinked polymeric materials also have a low coefficient of friction. Prior to elongating, it can be desirable to slightly crosslink the polymeric material, e.g., by treating the polymeric material with a relatively low ionizing radiation dose, such as less than about 50 kGy, to impart shape memory to the polymeric material.

In one aspect, the invention features methods of making crosslinked preforms that include one or more crosslinked polymeric materials. The methods include selecting a non-crosslinked preform having a first dimension and including a substantially non-crosslinked polymeric material; elongating the non-crosslinked preform in a first direction of the substantially non-crosslinked polymeric material to provide an elongated preform having a second dimension larger than the first dimension, wherein the elongated preform includes a substantially non-crosslinked, disentangled polymeric material; fixing the elongated preform to provide a fixed, elongated preform that includes a second substantially non-crosslinked, disentangled polymeric material; heating the fixed, elongated preform to a second temperature about (e.g., within about 8° C.) or above a melting point of the fixed substantially non-crosslinked, disentangled polymeric material to recover at least a portion of strain induced during elongating, and to provide a relaxed preform including a substantially non-crosslinked, relaxed polymeric material; and crosslinking the substantially non-crosslinked, relaxed polymeric material of the relaxed preform to provide a crosslinked preform that includes a crosslinked polymeric material.

In another aspect, the invention features methods of making a highly crosslinked preform that include a highly crosslinked polymeric material. The methods include selecting a non-crosslinked preform having a first dimension and including a substantially non-crosslinked polymeric material; crosslinking the substantially non-crosslinked polymeric material to provide a first crosslinked preform that includes a first crosslinked polymeric material having a first crosslink density of less than about 100 mol/m³; elongating the first crosslinked preform in a first direction of the first crosslinked polymeric material to provide a crosslinked, elongated preform having a second dimension larger than the first dimension and including a disentangled, crosslinked polymeric material; fixing the crosslinked, elongated preform to provide a fixed, crosslinked preform that includes a fixed crosslinked, disentangled polymeric material; heating the fixed, elongated preform to a second temperature at about or above a melting point of the fixed crosslinked, disentangled polymeric material to recover at least a portion of strain induced during elongating, and to provide a relaxed, crosslinked preform comprising a relaxed, crosslinked polymeric material; and further crosslinking the relaxed, crosslinked preform to provide a highly crosslinked preform that includes a highly crosslinked polymeric material having a second crosslink density greater than the first crosslink density.

In another aspect, the invention features methods of making a highly crosslinked preform that includes a highly crosslinked polymeric material. The methods include selecting a non-crosslinked preform having a first dimension and including a substantially non-crosslinked polymeric material; crosslinking the substantially non-crosslinked polymeric material with a first radiation dose of less than about 75 kGy (for example, less that about 50, 40, 30, 20, 10, or less than about 5 kGy) to provide a first crosslinked preform that includes a first crosslinked polymeric material having a first crosslink density; elongating the first crosslinked preform in a first direction of the first crosslinked polymeric material to provide a crosslinked, elongated preform having a second dimension larger than the first dimension, and that includes a disentangled, crosslinked polymeric material; fixing the crosslinked, elongated preform to provide a fixed, crosslinked preform that includes a fixed crosslinked, disentangled polymeric material; heating the fixed, elongated preform to a second temperature at about or above a melting point of the fixed crosslinked, disentangled polymeric material to recover at least a portion of strain induced during elongating and to provide a relaxed, crosslinked preform comprising a relaxed, crosslinked polymeric material; and further crosslinking the relaxed, crosslinked preform with a second radiation dose greater than the first radiation dose to provide a highly crosslinked preform that includes a highly crosslinked polymeric material having a second crosslink density greater than the first crosslink density.

In yet another aspect, the invention features compositions (for example, polymeric materials, polymeric preforms) made using the methods described herein.

Aspects and/or embodiments of the new methods can have one or more of the following features. The methods can further include elongating the non-crosslinked preform, fixing the elongated preform to provide a fixed, elongated preform, and heating the fixed, elongated preform one or more times to provide a relaxed preform prior to crosslinking. The methods can further include annealing the crosslinked preform, such as by heating the crosslinked preform to a temperature below a melting point of the crosslinked polymeric material. For example, annealing can include heating the crosslinked preform to a temperature that is above 100° C. below a melting point (e.g., between 100° C. below a melting point and about 1° C. below the melting point, or between 25° C. below a melting point to about 0.5° C. below the melting point) of the crosslinked polymeric material. The annealing can include applying a pressure of greater than 10 MPa to the crosslinked polymeric material, while heating the crosslinked material to a temperature below a melting point of the crosslinked polymeric material at the applied pressure for a time sufficient to provide an oxidation resistant crosslinked polymeric material. For example, the applied pressure can be greater than 25, 50, 100, 150, 200, 250, 300 MPa, or greater than 350 MPa. Sometimes, the annealing can include applying a pressure above nominal atmospheric pressure after heating the crosslinked polymeric material. The annealing can be carried out in the presence of a reactive gas that quenches residual reactive species trapped in the crosslinked polymeric material. For example, the reactive gas can include one or more unsaturated compounds, such as acetylene. The non-crosslinked preform can further include one or more molecules, each having a permanent dipole moment.

In addition, aspects and/or embodiments of the new methods can have one or more of the following features. The heating can include exposing the fixed, elongated preform to microwave radiation. The crosslinked preform can further include one or more molecules, each having a permanent dipole moment. The annealing can include exposing the crosslinked preform to microwave radiation. The fixed, elongated preform can be heated to a temperature less than about 3° C. below the melting point of the fixed, elongated preform, for a time of at most about 20 minutes (e.g., at most about 5 or 10 minutes).

The crosslinked preform that includes the crosslinked polymeric material can further include one or more antioxidants, such one or more phenolic compounds. The one or more phenolic compounds can include alpha-tocopherol.

The substantially non-crosslinked preform and/or the crosslinked preform can be in sheet or rod form. The substantially non-crosslinked preform and/or the crosslinked preform can be in the form of a medical device or portion thereof. The substantially non-crosslinked preform is in rod form having a longitudinal length, and the first dimension is the longitudinal length of the substantially non-crosslinked preform. The substantially non-crosslinked preform can be in sheet form having a length, a width, and a thickness, and the first dimension can be either the width or the length of the preform.

During or after elongating the non-crosslinked preform in the first direction, the preform is further elongated in a second direction, such as in a direction that is substantially perpendicular to the first direction. The elongating of the substantially non-crosslinked preform in the first direction can be performed by stretching the substantially non-crosslinked preform in the first direction and/or by compressing the substantially non-crosslinked preform in a direction substantially perpendicular to the first direction (e.g., around 90° relative to the first direction, around 85° relative to the first direction, or around 75° relative to the first direction; between 75° and 90°, or between 85° and 90° relative to the first direction).

In addition, aspects and or embodiments of the methods described herein can have one or more of the following features. The elongating the substantially non-crosslinked preform in the first direction is performed at a temperature of between 140° C. and about 180° C., such as between about 142° C. and about 160° C. The elongating the substantially non-crosslinked preform is performed by uniaxial tensile stress, biaxial tensile stress, uniaxial compression, channel-die compression, shear stress, biaxial compression, and/or biaxial compression followed by elongation. The second dimension can be between about 0.5 percent and 5,000 percent larger (e.g., between about 1 percent to 500 percent larger, between about 5 percent and 100 percent larger, or between about 10 percent and 50 percent larger) than the first dimension. The fixing of the elongated preform can result from stretching the elongated preform in a manner so as to increase a material melting point above a temperature at which the stretching is performed. During elongation, there can be strain-induced crystallization. The fixing of the elongated preform can include cooling the elongated preform below a material melting point.

In addition, aspects and/or embodiments of the methods can have one or more of the following features. The crosslinking can be performed with an ionizing radiation, such as with gamma rays or high energy electrons. The ionizing radiation can be applied at a total dose of greater than 1 kGy, such as greater than about 25 kGy, 50 kGy, or 500 KGy. The ionizing radiation can be applied at a dose rate of greater than 0.1 kGy/hour. Crosslinking can occur below a melting point of the fixed substantially non-crosslinked, elongated polymeric material, or at an elevated temperature (e.g., greater than 80° C.) but still below a melting point of the fixed substantially non-crosslinked, elongated material. The substantially non-crosslinked, disentangled material and the fixed substantially non-crosslinked, disentangled polymeric material can each have a different crystallinity and/or a different melting point. The substantially non-crosslinked polymeric material can include a polyethylene, such as an ultra-high molecular weight polyethylene. The substantially non-crosslinked polymeric material can include a melt processible polymer or a blend of melt processible polymers. The crosslinking can occur at about nominal atmospheric pressure.

The crosslinking of the substantially non-crosslinked polymeric material can include exposing the non-crosslinked preform to a radiation dose of less than about 10 kGy, such as less than about 8 kGy or less than about 5 kGy. The second crosslink density can be greater than about 150 mol/m³, such as greater than about 160, 175, 200 or 250 mol/m³. The crosslinking of the relaxed, crosslinked preform can include exposing the relaxed, crosslinked preform to a radiation dose of greater than about 25 kGy, such as greater than about 50 kGy or greater than about 100 kGy. The first crosslinked preform that includes the first crosslinked polymeric material can have a molecular weight between crosslinks of greater than about 7,500 g/mol, such as greater than about 10,000 g/mol, such as greater than about 15,000 g/mol or greater than about 25,000 g/mol. Crosslinking the substantially non-crosslinked polymeric material and/or crosslinking the relaxed, crosslinked preform can be performed in the absence of oxygen, such as in the presence of an inert gas, e.g., nitrogen, helium, argon, or mixtures of these gases. The substantially non-crosslinked polymeric material can include one or more antioxidants.

Aspects and/or embodiments of the methods can have any one of, or combinations of, the following advantages. The crosslinked materials are stable over extended periods of time and are resistant to oxidation. The crosslinked polymeric materials are highly crystalline, e.g., having a crystallinity of greater than 54 percent, e.g., 57 percent or higher. The polymeric materials have a low degree of chain entanglement, which can improve crosslinking degree, quality, and/or efficiency. The crosslinked polymeric materials are highly crosslinked, e.g., having a high crosslink density, e.g., greater than 100 mol/m³, and/or a relatively low molecular weight between crosslinks, e.g., less than 7500 g/mol. When the crosslinked polymeric material is UHMWPE, it can have a relatively high melting point, e.g., greater than 140° C., in combination with a relatively high degree of crystallinity, e.g., greater than about 52 percent. Parts formed from the crosslinked polymeric material have high wear resistance, enhanced stiffness, as reflected in flexural and tensile moduli, a high level of fatigue and crack propagation resistance, and enhanced creep resistance. Some of the crosslinked polymeric materials have a low coefficient of friction. In addition, the described methods are easy to implement.

An “antioxidant” is a material, e.g., a single compound or polymeric material, or a mixture of compounds and/or polymeric materials, that reduces the rate of oxidation reactions.

An “oxidation resistant crosslinked polymeric material” is one that loses less than 25 percent of its elongation at break (ASTM D412, Die C, 2 hours, and 23° C.) after treatment in a bomb reactor filled with substantially pure oxygen gas to a pressure of 5 atmospheres, heated to 70° C. temperature, and held at this temperature for a period of two weeks.

A “substantially non-crosslinked polymeric material” is one that is dissolvable in a solvent, whereas a “substantially crosslinked polymeric material” is one that is not dissolvable in any solvent, although it may swell.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### DESCRIPTION OF DRAWINGS

FIG. 1 is a schematic view of a semi-crystalline polymeric material having highly entangled polymeric chains.

FIGS. 2A and 2B are schematic side views of polymeric rod stock prior to stretching, and after stretching along a single axis, respectively.

FIGS. 2C and 2D are schematic top views of polymeric sheet stock prior to stretching, and after stretching along a two axes.

FIG. 3A is a side view of a ram extrusion and stretching process for making polymeric rods oriented along a single axis.

FIG. 3B is a schematic side view of bar stock undergoing compression and elongation through a diameter-reducing die.

FIG. 4 is a series of transverse cross-sectional views of several possible rod geometries.

FIG. 5 is a side view of a process for stretching polymeric sheets along two axes.

FIG. 6A is a perspective, cut-away view of a gamma irradiator.

FIG. 6B is an enlarged perspective view of region 6B of FIG. 6A.

FIG. 7 is a schematic perspective view of a cylindrical plug cut from an extruded rod made from substantially non-crosslinked ultrahigh molecular weight polyethylene (UHMWPE).

FIG. 8 is a cross-sectional view of a crosslinked UHMWPE rod in a mold disposed within a furnace.

FIG. 9 is a partial cross-sectional view of a hip prosthesis having a bearing formed from crosslinked UHMWPE.

FIG. 10 is a DSC thermogram of GUR 1020 UHMWPE containing 0.05% Vitamin E before uniaxial compression (CR=1.0) and after compression (CR=12.1) in the melt-state (higher-order peaks marked with arrows).

FIG. 11 is a DSC thermogram of GUR 1020 UHMWPE before compression (CR=1.0) and after compression (CR=10.4) in the melt-state (higher-order peaks marked with arrows).

FIG. 12 is a DSC thermogram of GUR 1020 UHMWPE containing 0.05% Vitamin E before uniaxial compression (CR=1.0) and after compression (CR=12.2) in the melt-state (higher-order peaks marked with arrows).

FIG. 13 is a DSC thermogram of GUR 1020 UHMWPE containing 0.05% Vitamin E before uniaxial compression (Control) and after uniaxial melt-state compression to a CR=10.9 at 140.5° C. followed by no annealing and annealing isothermally for 24 hours at an annealing temperature (Ta) of 131° C., 133° C., 135° C. and 137° C. (higher-order peaks marked with arrows).

FIG. 14 is a DSC thermogram of GUR 1020 UHMWPE containing 0.05% Vitamin E before compression (CR=1.0) and after compression (CR=4.0) in the solid-state.

FIG. 15 is a DSC thermogram of GUR 1020 UHMWPE before uniaxial compression (CR=1.0) and after compression (CR=3.5) in the solid-state.

### DETAILED DESCRIPTION

Described herein are novel methods of processing polymeric materials, such as UHMWPE, that can include an antioxidant, such as Vitamin E or alpha-tocopherol. For example, in some instances, as described in more detail herein, polymeric materials, e.g., in the shape of a cylinder, are elongated in a solid state or molten state to disentangle the chains of the polymer. Samples can be re-melted (if the stretching was performed in the solid state) to recover some of the induced strain and make the material more anisotropic. Slightly crosslinking prior to elongating can impart shape memory into the polymeric material, allowing for a larger degree of strain relief. To reduce the likelihood of re-entanglement when the material is melted after stretching, it can be desirable to heat the polymeric material to a temperature only slightly above the melting temperature, such as between about 0.1° C. to about 20° C. above the melting temperature of the stretched polymeric material, e.g., within 0.1° C. and 5° C. above the melting temperature. Generally, it is preferable not to maintain the polymeric material at this melting temperature for long time periods, since this can also facilitate re-entanglements. Upon strain recovery, the polymeric material can be cooled to a temperature below the melting temperature and then irradiated with ionizing radiation, e.g., gamma or electron beam radiation, to a dose range of from about 1 kGy to about 1000 kGy, e.g., between about 50 kGy to about 500 kGy. Any post-melting cooling or re-crystallization can be done rapidly (e.g., by quenching) if a low crystallinity product is desired. The polymeric material can later be annealed at atmospheric pressure or high pressure to thicken the crystals and increase overall crystallinity.

### General Methodology

Generally, crosslinked, oxidation resistant polymeric materials (e.g., in a desired shape) that have desirable mechanical properties, such as high wear resistance and fatigue and crack propagation resistance, are made using a four-step process after selecting a non-crosslinked preform having a first dimension, such as a length or a width, that includes a substantially non-crosslinked polymeric material. First, non-crosslinked preform is elongated in a first direction to provide an elongated preform having a second dimension larger than the first dimension and including a first substantially non-crosslinked, disentangled polymeric material. Second, the elongated preform is fixed to provide a fixed, elongated preform in which the polymeric material is fixed, substantially non-crosslinked, and disentangled. Third, the fixed, elongated preform is heated to a second temperature about (e.g., at or slightly below or above) a melting point of the substantially non-crosslinked, disentangled polymeric material, to recover at least a portion of strain induced during elongating and to provide a relaxed preform in which the polymeric material is substantially non-crosslinked and relaxed. Fourth, the polymeric material of the relaxed preform is crosslinked to provide a crosslinked preform that includes a crosslinked polymeric material.

In some embodiments, the elongation, fixing, and/or heating steps can be repeated multiple times (e.g., twice, three times, four times, five times, six times, seven times, eight times, nine times, or ten times) prior to crosslinking. For example, a cycle can include elongation, fixing, followed by heating, and the cycle can be repeated multiple times (e.g., twice, three times, four times, five times, six times, seven times, eight times, nine times, or ten times) prior to crosslinking the resulting relaxed preform. The resulting relaxed preform can have superior properties, such as an increased mechanical and/or chemical stability.

Any of the preforms, such as a crosslinked preform, may be annealed, as will be described in more detail below. For example, to anneal the crosslinked preform, the annealing can include heating the crosslinked preform below a melting point of the crosslinked polymeric material. As will be described in more detail below, any preform may be annealed in the presence of a reactive gas or quenching material, such as acetylene, that can quench residual reactive species, such as radicals and radical cations that may be trapped in a polymeric material, such as a crosslinked material. Generally, the reactive gas can aid in crosslinking of a polymeric material by acting as a bridge between two reactive moieties, and it can also terminate such reactive moieties, which can prevent oxidation over the long-term.

Any of the preforms described herein may include one or more antioxidants, such as Vitamin E, to reduce oxidation of the materials of the preform, such as during processing and/or use.

Any of the preforms described herein can include one or more molecules that include a permanent dipole moment so that any preform that includes such a molecule can be heated using microwave energy, e.g., during annealing.

Any preform prior to elongation can be slightly crosslinked, such as by applying a an ionizing radiation dose of less than 75 kGy, e.g., less than 50 kGy, 25 kGy, 10 kGy or less than 5 kGy. For example, the applied radiation dose can be between about 5 kGy and about 60 kGy, or between about 10 kGy and about 50 kGy. Doing so can impart shape memory to the preform so that substantially all stresses induced during elongation can be relieved.

Prior to elongation, the polymeric material of any preform can be melted, and then cooled (e.g., crystallized) under pressure, such as a pressure greater than about 10 MPa, e.g., between 10 MPa and 100 MPa, or between 25 MPa and about 75 MPa. High pressure crystallization can aid in disentangling polymer chains, which can improve the mechanical properties of the resulting preforms.

In any method described herein, elongation followed by recovery can be performed multiple times. In such instances, each elongation can be performed by uniaxial tensile stress, biaxial tensile stress, uniaxial compression, channel-die compression, shear stress or biaxial compression.

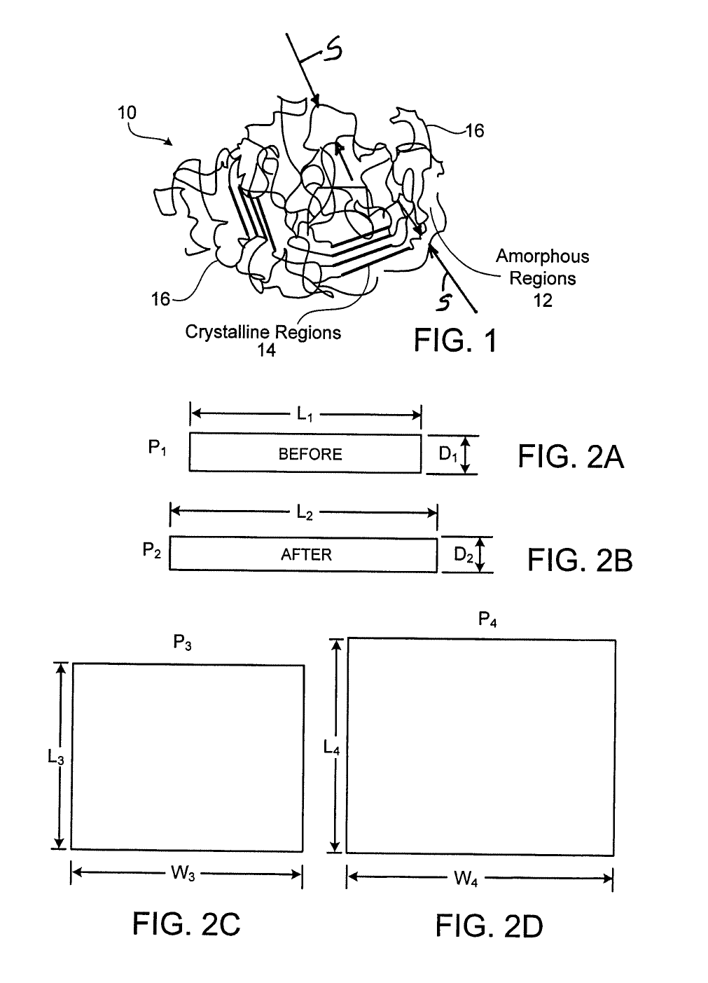

Referring now to FIG. 1, a semi-crystalline polymeric material 10 includes amorphous regions 12 and crystalline regions 14, which are connected by a network of polymeric chains 16 that have a spacing (S) between adjacent polymeric chains. Elongation of such a polymeric material can not only increase crystallinity of the crystalline regions (e.g., stress-induced crystallization), but can also reduce the average spacing (S) between adjacent chains. Reducing the spacing can allow for a closer approach of adjacent polymeric chains, which can enhance crosslinking of the polymeric materials.

Referring now to FIG. 2A, a cylindrical preform P₁ prior to elongation has a length L₁ and a diameter D₁. As shown in FIG. 2B, after elongation of cylindrical preform P₁ along a single axis that run along the length of the preform (e.g., by stretching in tensile mode), cylindrical preform P₂ is provided that has (relative to P₁) an increased length L₂, and a diminished diameter D₂. Generally, the polymeric material of preform P₂ is less entangled than is the polymeric material of preform P₁.

Referring now to FIG. 2C, sheet-form preform P₃ prior to elongation has a length L₃, a width W₃ and a thickness T₃. As shown in FIG. 2D, after elongation of sheet-form preform P₃ along a first axis that runs along the length of the preform and a second axis that runs the width of the preform and that is perpendicular to the first axis, sheet-form preform P₄ is provided that has (relative to P₃) an increased length L₄ and width W₄ and a diminished thickness T₄. Generally, the biaxially oriented polymeric material of preform P₄ is less entangled than is the polymeric material of preform P₃.

In many of the methods described herein, the fixing of an elongated preform is accomplished under conditions so as to prevent re-entanglement of polymer chains during the fixing. For example, the material can be quenched rapidly to reduce the mobility of the polymeric chains.

Crosslinked, oxidation resistant polymeric materials (e.g., in a desired shape) that have desirable mechanical properties, such as high wear resistance and fatigue and crack propagation resistance, can be made by selecting a non-crosslinked preform having a first dimension and including a substantially non-crosslinked polymeric material. The substantially non-crosslinked polymeric material can be crosslinked to provide a first crosslinked preform that includes a first crosslinked polymeric material having a first crosslink density of less than about 100 mol/m³, such as less than about 95, 85, 75, or less than 60 mol/m³. In other embodiments, the first crosslinked polymeric material can have a crosslink density of or between about 25 mol/m³ and about 100 mol/m³, such as between about 35 mol/m³ and about 90 mol/m³, or between about 40 mol/m³ and about 85 mol/m³. The first crosslinked preform is elongated in a first direction at a first temperature to provide a crosslinked, elongated preform having a second dimension larger than the first dimension and including a first disentangled, crosslinked polymeric material. The crosslinked, elongated preform is fixed to provide a fixed, crosslinked preform that includes a second crosslinked, disentangled polymeric material. The fixed, elongated preform is heated to a second temperature about or above a melting point of the second crosslinked, disentangled polymeric material to recover at least a portion of strain induced during elongating and to provide a relaxed, crosslinked preform including a relaxed, crosslinked polymeric material. Finally, the relaxed, crosslinked preform that includes the relaxed, crosslinked polymeric material is even further crosslinked to provide a more highly crosslinked preform that includes a highly crosslinked polymeric material having a second crosslink density greater than the first crosslink density.

For example, in still other embodiments, crosslinked, oxidation resistant polymeric materials (e.g., in a desired shape) that have desirable mechanical properties, such as high wear resistance and fatigue and crack propagation resistance, are made by selecting a non-crosslinked preform having a first dimension and that includes a substantially non-crosslinked polymeric material. The substantially non-crosslinked polymeric material is crosslinked with a first ionizing radiation dose of less than about 75 KGy or less than about 50 kGy, such as less than about 40, 30, 20, 10, or less than about 5 kGy, to provide a first crosslinked preform that includes a first crosslinked polymeric material having a first crosslink density. The first crosslinked preform is elongated in a first direction at a first temperature to provide a crosslinked, elongated preform having a second dimension larger than the first dimension and that includes a first disentangled, crosslinked polymeric material. The crosslinked, elongated preform is fixed to provide a fixed, crosslinked preform that includes a second crosslinked, disentangled polymeric material. The fixed, elongated preform is heated to a second temperature about or above a melting point of the second crosslinked, disentangled polymeric material to recover at least a portion of strain induced during elongating and to provide a relaxed, crosslinked preform that includes a relaxed, crosslinked polymeric material. The relaxed, crosslinked preform that includes the relaxed, crosslinked, polymeric material is further crosslinked with a second ionizing radiation dose, e.g., that is greater than the first dose, to provide a highly crosslinked preform that includes a highly crosslinked polymeric material having a second crosslink density greater than the first crosslink density.

### Polymeric Materials

The substantially non-crosslinked polymeric materials can be, e.g., a polyolefin, e.g., a polyethylene such as UHMWPE, a low density polyethylene (e.g., having a density of between about 0.92 and 0.93 g/cm³, as determined by ASTM D792), a linear low density polyethylene, a very-low density polyethylene, an ultra-low density polyethylene (e.g., having a density of between about 0.90 and 0.92 g/cm³, as determined by ASTM D792), a high density polyethylene (e.g., having a density of between about 0.95 and 0.97 g/cm³, as determined by ASTM D792), a polypropylene, a polyester such as polyethylene terephthalate, a polyamide such as nylon 6, 6/12, or 6/10, a polyethyleneimine, an elastomeric styrenic copolymer such as styrene-ethylene-butylene-styrene copolymer, a copolymer of styrene and a diene such as butadiene or isoprene, a polyamide elastomer such as a polyether-polyamide copolymer, an ethylene-vinyl acetate copolymer, or compatible blends of any of these polymers. The substantially non-crosslinked polymeric material can be processed from the melt into a desired shape, e.g., using a melt extruder, or an injection molding machine, or it can be pressure processed with or without heat, e.g., using compression molding or ram extrusion.

The substantially non-crosslinked polymeric material can be purchased in various forms, e.g., as powder, flakes, particles, pellets, or other shapes such as rods (e.g., cylindrical rod). Powder, flakes, particles, or pellets can be shaped into a preform by extrusion, e.g., ram extrusion, melt extrusion, or by molding, e.g., injection or compression molding. Purchased shapes can be machined, cut, or otherwise worked to provide the desired shape. Polyolefins are available, e.g., from Hoechst, Montel, Sunoco, Exxon, and Dow; polyesters are available from BASF and Dupont; nylons are available from Dupont and Atofina, and elastomeric styrenic copolymers are available from the KRATON Polymers Group (formally available from Shell). If desired, the materials may be synthesized by known methods. For example, the polyolefins can be synthesized by employing Ziegler-Natta heterogeneous metal catalysts, or metallocene catalyst systems, and nylons can be prepared by condensation, e.g., using transesterification.

In some embodiments, it is desirable for the substantially non-crosslinked polymeric material to be substantially free of biologically leachable additives that could leach from an implant in a human body or that could interfere with the crosslinking of the substantially non-crosslinked polymeric material.

In particular embodiments, the polyolefin is UHMWPE. For the purposes of this disclosure, an UHMWPE can consist essentially of substantially linear, non-branched polymeric chains consisting essentially of —CH₂CH₂— repeat units. The polyethylene can have an average molecular weight in excess of about 500,000, e.g., greater than 1,000,000, 2,500,000, 5,000,000, or even greater than 7,500,000, as determined using a universal calibration curve. In such embodiments, the UHMWPE can have a degree of crystallinity of greater than 50 percent, e.g., greater than 51 percent, 52 percent, 53 percent, 54 percent, or even greater than 55 percent, and can have a melting point of greater than 135° C., e.g., greater than 136, 137, 138, 139, or even greater than 140° C. The degree of crystallinity of the UHMWPE is calculated by knowing the mass of the sample (in grams), the heat absorbed by the sample in melting (E in J/g), and the heat of melting of polyethylene crystals (ΔH=291 J/g). Once these quantities are known, degree of crystallinity is then calculated using the formula below:

Degree of Crystallinity=E/(sample weight)ΔH

Differential scanning calorimetry (DSC) can also be used to measure the degree of crystallinity of the UHMWPE sample. To do so, the sample is weighed to a precision of about 0.01 milligrams, and then the sample is placed in an aluminum DSC sample pan. The pan holding the sample is then placed in a differential scanning calorimeter, e.g., a TA Instruments Q-1000 DSC, and the sample and reference are heated at a heating rate of about 10° C./minute from about −20° C. to 180° C., cooled to about −10° C., and then subjected to another heating cycle from about −20° C. to 180° C. at 10° C./minute. Heat flow as a function of time and temperature is recorded during each cycle. Degree of crystallinity is determined by integrating the enthalpy peak from 20° C. to 160° C., and then normalizing it with the enthalpy of melting of 100 percent crystalline polyethylene (291 J/g). Melting points can also be determined using DSC.

In some embodiments, the substantially non-crosslinked polymeric material is substantially amorphous. In some embodiments, the substantially non-crosslinked polymeric material includes one or more antioxidants, such as any of the antioxidants described herein. In some embodiments, the substantially non-crosslinked polymeric material includes one or more infused antioxidants.

### Elongation and Fixing

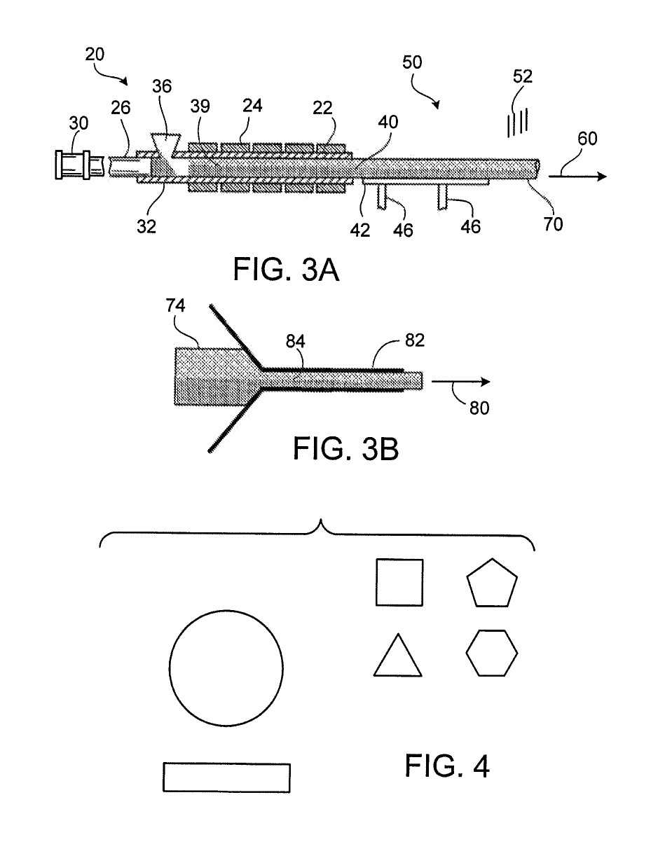

Referring to FIG. 3A, in some implementations, a ram extruder 20 includes a tubular barrel 22 having concentric heating elements 24, and a ram 26, which is reciprocated by a hydraulic unit 30 in a proximal end 32 of the barrel 22. A supply unit 36 feeds the charge, such as ultra-high molecular weight polyethylene, into the barrel, which forms a coalesced material 39 that moves along barrel 22 to finally become a sintered extrudate 40 upon exiting barrel 22. Sintered extrudate 40 is then delivered to a cooling stand 42, which is supported by legs 46. The sintered extrudate is then reheated at a heating station 50 by elements 52, e.g., above a melting point of material of the sintered extrudate, and elongated along a longitudinal axis of the extrudate (as indicated by arrow 60), which is commonly referred to as the machine direction, to provide an elongated extrudate 70. The elongated extrudate is then fixed at its elongated length, e.g., by cooling the extrudate. The elongated and fixed extrudate can then be cut into preforms of a desired length.

Referring now to FIG. 3B, a preformed material 74 can be elongated, e.g., by drawing the material in a first direction (as indicated by arrow 80) while the material is undergoing axial compression through a diameter-reducing die that is heated, e.g., above a melting point of the polymeric material of preform 74. After elongation to a desired extent, the preform is fixed at a desired length, e.g., by cooling. As shown, the diameter-reducing die has a lead-in portion 84 that allows for a gradual axial compression of material entering the die. In some implementations, the diameter of the material exiting the die is 5 percent less, e.g., 10 percent, 15 percent, 25 percent, 50 percent, or even 80 percent less than a diameter the material entering the die.

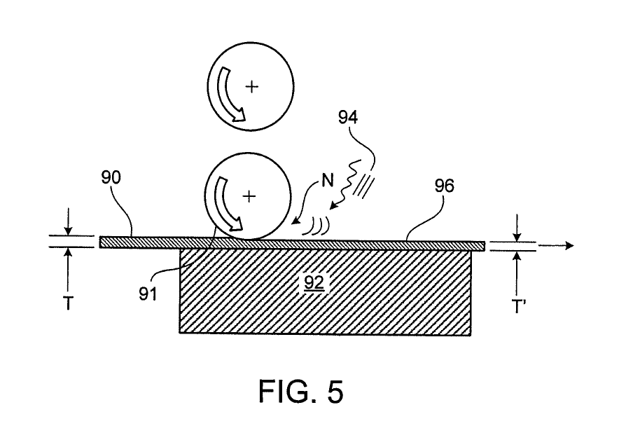

Referring now to FIG. 4, preforms of many different shapes can be produced and elongated. As shown, the preform can be, e.g., circular, rectangular, square, triangular, pentagonal, or hexagonal in transverse cross-section.

Referring to FIG. 5, a preformed sheet material 90 can be elongated in two directions, corresponding to a machine direction and a transverse direction, by passing the sheet material through a nip N defined by a rotating pressure roll 91 and a table 92. For example, the sheet material can be pre-heated, e.g., above a melting point of polymeric material of the sheet material 90, or the pressure roll may be heated, e.g., above a melting point of polymeric material of sheet material, to aid in effecting the transformation. Briefly, the sheet material 90 having a thickness T is draw into a nip having a maximum height in a direction normal to the table that is less than the thickness T, thereby reducing its thickness to T′. Post nip, the preform is fixed, e.g., by cooling with a fan unit 94 that directs cooled air onto the thinned preform. Thinned preform material 96 has an increased to length and width relative to preform material 90.

In some embodiments, the elongation is performed at a first temperature that is below a melting point of the substantially non-crosslinked material (e.g., 10° C., 8° C., 6° C., 5° C., 2° C. or 1° C. below). In some embodiments, the elongation is performed at a temperature that is above a melting point (e.g., 1° C., 2° C., 3° C., 5° C., 6° C., 8° C., or 10° C. above), of the substantially non-crosslinked polymeric material.

While a few embodiments for elongating the substantially non-crosslinked material, e.g., as a preform, have been shown, other elongating embodiments are possible. More generally, elongation can be achieved, e.g., by uniaxial tensile stress, biaxial tensile stress, uniaxial compression, channel-die compression, shear stress, biaxial compression, or combinations thereof.

Generally, in some embodiments, a stretched dimension is, e.g., between about 0.5 percent and 2,500 percent larger than an unstretched dimension, e.g., between about 1.0 percent and 1,000 percent larger, or between about 2.0 percent and 100 percent larger.

In some embodiments, the fixing of the elongated preform results from stretching the first elongated preform in a manner so as to increase a material melting point above a temperature at which the stretching is performed.

In some embodiments, during elongation, there is strain-induced crystallization.

In some embodiments, the fixing is accomplished by cooling the preform, e.g., by contacting, e.g., by submerging, the substantially non-crosslinked polymeric material with a fluid having a temperature below about 0° C., e.g., liquid nitrogen with a boiling point of about 77 K. In some embodiments, the substantially non-crosslinked polymeric material can be contacted with iced water, or salted ice water. This can allow for rapid cooling rates, especially of skin or surface portions of the substantially non-crosslinked polymeric material. In such cases, cooling rates can be, e.g., from about 50° C. per minute to about 500° C. per minute, e.g., from about 100° C. to about 250° C. per minute. Rapid cooling rates can result in more nucleation sites, smaller crystallites, and a material having a higher surface area. Cooling can also reduce crystallinity.

### Crosslinking

In some embodiments, the crosslinking occurs at a temperature from about −25° C. to above a melting point of the substantially non-crosslinked polymeric material, e.g., from about −10° C. to about a melting point of the substantially non-crosslinked polymeric material, e.g., room temperature to about the melting point. Irradiating above a melting point of the substantially non-crosslinked polymeric material can, e.g., increase crosslink density.

In some embodiments, crosslinking occurs at a relatively elevated temperature. An elevated temperature can help limit the generation and/or propagation of free radical species, such that a smaller quantity of antioxidant can be needed in a polymer compared to a polymer that is not crosslinked at a relatively elevated temperature. The elevated temperature can range, for example, from 80 to 130° C. (e.g., from 80 to 120° C., from 80 to 110° C., or from 80 to 100° C.). In some embodiments, the upper bound of the temperature range can vary, but is below a melting point of the non-crosslinked polymer.

In some embodiments, the crosslinking occurs at a pressure, e.g., from about nominal atmospheric pressure to about 50 atmospheres of pressure, e.g., from about nominal atmospheric pressure to about 5, 10, 20, or 30 atmospheres of pressure. Crosslinking above atmospheric pressure can, e.g., increase crosslink density.

In some embodiments, the crosslinking is performed at a temperature that substantially prevents re-entanglement of polymer chains.

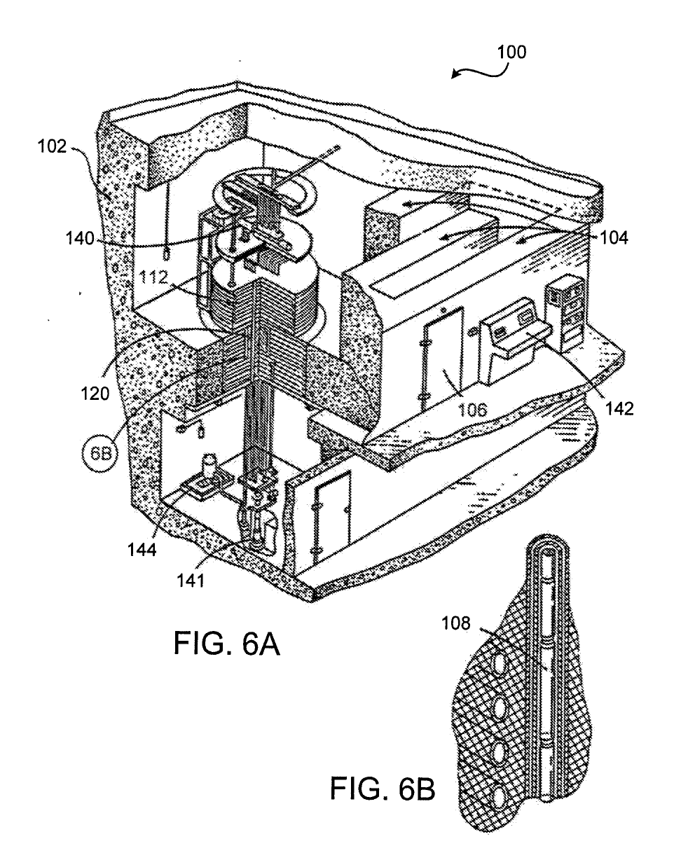

In some embodiments, an ionizing radiation (e.g., an electron beam, x-ray radiation, or gamma radiation) is employed to crosslink the substantially non-crosslinked polymeric material. In specific embodiments, gamma radiation is employed to crosslink the substantially non-crosslinked polymeric material. Referring to FIGS. 6A and 6B, a gamma irradiator 100 includes gamma radiation sources 108, e.g., ⁶⁰Co pellets, a working table 110 for holding the substantially non-crosslinked polymeric material to be irradiated, and storage 112, e.g., made of a plurality iron plates, all of which are housed in a concrete containment chamber 102 that includes a maze entranceway 104 beyond a lead-lined door 106. Storage 112 includes a plurality of channels 120, e.g., 16 or more channels, allowing the gamma radiation sources 108 to pass through storage 112 on their way proximate the working table 110.

In operation, the substantially non-crosslinked polymeric material to be irradiated is placed on working table 110. The irradiator is configured to deliver the desired dose rate and monitoring equipment is connected to experimental block 140. The operator then leaves the containment chamber 102, passing through the maze entranceway 104 and through the lead-lined door 106. The operator uses a control panel 142 to instruct a computer to lift the radiation sources 108 into working position using cylinder 141 attached to a hydraulic pump 144. If desired, the sample can be housed in a container that maintains the sample under an inert atmosphere such as nitrogen or argon.

In embodiments in which the irradiating is performed with electromagnetic radiation (e.g., as above), the electromagnetic radiation can have energy per photon of greater than 10² eV, e.g., greater than 10³, 10⁴, 10⁵, 10⁶, or even greater than 10⁷ eV. In some embodiments, the electromagnetic radiation has an energy per photon of between 10⁴ and 10⁷, e.g., between 10⁵ and 10⁶ eV. The electromagnetic radiation can have a frequency of e.g., greater than 10¹⁶ Hz, greater than 10¹⁷ Hz, 10¹⁸, 10¹⁹, 10²⁰, or even greater than 10²¹ Hz. In some embodiments, the electromagnetic radiation has a frequency of between 10¹⁸ and 10²² Hz, e.g., between 10¹⁹ to 10²¹ Hz.

In some embodiments, a beam of electrons is used as the radiation source. Electron beams can be generated, e.g., by electrostatic generators, cascade generators, transformer generators, low energy accelerators with a scanning system, low energy accelerators with a linear cathode, linear accelerators, and/or pulsed accelerators. Electrons as an ionizing radiation source can be useful to crosslink outer portions of the substantially non-crosslinked polymeric material, e.g., inwardly from an outer surface of less than 0.5 inch, e.g., less than 0.4 inch, 0.3 inch, 0.2 inch, or less than 0.1 inch. In some embodiments, the energy of each electron of the electron beam is from about 0.3 MeV to about 10.0 MeV (million electron volts), e.g., from about 0.5 MeV to about 3.0 MeV, or from about 0.7 MeV to about 1.50 MeV.

In some embodiments, the irradiating (with any radiation source) is performed until the sample receives a dose of at least 0.25 Mrad (2.5 kGy), e.g., at least 1.0 Mrad (10 kGy), at least 2.5 Mrad (25 kGy), at least 5.0 Mrad (50 kGy), or at least 10.0 Mrad (100 kGy). In some embodiments, the irradiating is performed until the sample receives a dose of between 1.0 Mrad and 6.0 Mrad, e.g., between 1.5 Mrad and 4.0 Mrad.

Prior to elongating, it can be desirable to slightly crosslink the polymeric material, e.g., by treating the polymeric material with a relatively low radiation (e.g., ionizing radiation) dose, such as less than about 75 kGy, less than about 50 kGy, less than about 35 KGy, less than about 25 kGy, less than about 15 kGy, less than about 10 kGy, less than about 7.5 kGy, less than about 5 kGy, less than about 4 kGy or less than about 3 kGy. Slightly crosslinking a polymeric material can impart shape memory into the polymeric material, which can help relieve stress imparted during elongation when the material is heated at or above a melting point of the polymeric material. In some embodiments, a dose of between about 2.5 kGy to about 25 kGy is utilized, e.g., from about 4 kGy to about 20, or between about 5.0 and about 15 kGy.

In some embodiments, the irradiating is performed at a dose rate of between 5.0 and 1500.0 kilorads/hour, e.g., between 10.0 and 750.0 kilorads/hour, or between 50.0 and 350.0 kilorads/hours. Low rates can generally maintain the temperature of the sample, while high dose rates can cause heating of the sample.

In some embodiments, radical sources, e.g., azo materials, e.g., monomeric azo compounds such as 2,2′-azobis(N-cyclohexyl-2-methylpropionamide) (I), or polymeric azo materials such as those schematically represented by (II) in which the linking chains include polyethylene glycol units (N is, e.g., from about 2 to about 50,000, between about 3 and about 10,000 or between about 5 and about 1,000), and/or polysiloxane units, peroxides, e.g., benzoyl peroxide, or persulfates, e.g., ammonium persulfate (NH₄)₂S₂O₈, are employed to crosslink the substantially non-crosslinked polymeric material.

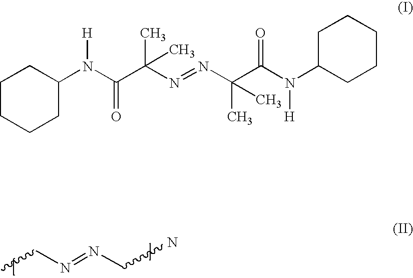

Azo materials are available, for example, from Wako Chemicals USA, Inc. of Richmond, Va.

Generally, to crosslink the substantially non-crosslinked polymeric material, the material is mixed, e.g., powder or melt mixed, with the radical source, e.g., using a roll mill, e.g., a Banbury® mixer or an extruder, e.g., a twin-screw extruder with counter-rotating screws. An example of a Banbury® mixer is the F-Series Banbury® mixer, manufactured by Farrel. An example of a twin-screw extruder is the WP ZSK 50 MEGAcompounder™, manufactured by Krupp Werner & Pfleiderer. Generally, the compounding or powder mixing is performed at the lowest possible temperature to prevent premature crosslinking. The sample is then formed into the desired shape, and further heated (optionally with application of pressure) to generate radicals in sufficient quantities to crosslink the sample.

The degree of crosslinking can be controlled by an initial concentration of the radical source. For example, mild crosslinking can be effected by using an initial concentration of the radical source of from about 0.01 percent by weight to about 1 percent by weight, e.g., 0.05 percent by weight to about 0.5 percent by weight. For example, heavy crosslinking can be effected by using an initial concentration of the radical source of from about 2 percent by weight to about 7.5 percent by weight, e.g., 2.5 percent by weight to about 5 percent by weight.

### Measuring Crosslink Density and Molecular Weight Between Crosslinks

Crosslink density measurements are performed following the procedure outlined ASTM F2214-03. Briefly, rectangular pieces of the crosslinked UHMWPE are set in dental cement, and sliced into thin sections that are 2 mm thick. Small sections are cut out from these thin sections using a razor blade, giving test samples that are 2 mm thick by 2 mm wide by 2 mm high. A test sample is placed under a quartz probe of a dynamic mechanical analyzer (DMA), and an initial height of the sample is recorded. Then, the probe is immersed in o-xylene, heated to 130° C., and held at this temperature for 45 minutes. The UHMWPE sample is allowed to swell in the hot o-xylene until equilibrium is reached. The swell ratio qₛ for the sample is calculated using a ratio of a final height H_{f} to an initial height H₀ according to formula (1):

qₛ=[H_{f}/H₀]³ (1).

The crosslink density v_{d} is calculated from qₛ, the Flory interaction parameter χ, and the molar volume of the solvent φ₁ according to formula (2):

$${v}_{d} = \frac{ln ( 1 - {q}_{s}^{- 1} ) + {q}_{s}^{- 1} + χ {q}_{s}^{- 2}}{{φ}_{1} ( {q}_{s}^{- 1 / 3} - {q}_{s}^{- 1} / 2 )} , \qquad ( 2 )$$

where χ is 0.33+0.55/qs, and φ₁ is 136 cm³/mol for UHMWPE in o-xylene at 130° C. Molecular weight between crosslinks M_{c} can be calculated from v_{d}, and the specific volume of the polymer ν according to formula (3):

M_{c}=(νv_{d})⁻¹ (3).

Measurement of swelling, crosslink density and molecular weight between crosslinks is described in Muratoglu et al., Biomaterials, 20, 1463-1470 (1999).

### Annealing

Any material described herein (crosslinked or non-crosslinked) can be annealed. For example, a preform can be annealed below or above a melting point of a material of the preform.

For example, after crosslinking, a pressure of greater than 10 MPa is applied to the crosslinked polymeric material, while heating the crosslinked material below a melting point of the crosslinked polymeric material at the applied pressure for a sufficient time to substantially reduce the reactive species trapped within the crosslinked polymeric material matrix, e.g., free radicals, radical cations, or reactive multiple bonds. Quenching such species produces an oxidation resistant crosslinked polymeric material. The high pressures, and temperatures employed also increase the crystallinity of the crosslinked polymeric material, which can, e.g., improve wear performance.

In some embodiments, the pressure applied is greater than 25 MPa, e.g., greater than 50 MPa, 75 MPa, 100 MPa, 150 MPa, 200 MPa, 250 MPa, 350 MPa, 500 MPa, 750 MPa, 1,000 MPa, or greater than 1,500 MPa. In some embodiments, the pressure is maintained for greater than 30 seconds, e.g., greater than 45 seconds, 60 seconds, 2.5 minutes, 5.0 minutes, 10 minutes, 20 minutes, 30 minutes, 60 minutes, greater than 90 minutes, or even greater than 120 minutes, before release of pressure back to nominal atmospheric pressure.

In some embodiments, prior to the application of any pressure above nominal atmospheric pressure, the crosslinked polymeric material is heated to a temperature that is between about 100° C. below a melting point of the crosslinked polymeric material to about 1° C. below the melting point of the crosslinked polymeric material, e.g., about 25° C. below the melting point of the crosslinked polymeric material to about 0.5° C. below a melting point of the crosslinked polymeric material. This can enhance crystallinity of the crosslinked polymeric material prior to the application of any pressure.

In some embodiments, a pressure of above about 250 MPa is applied at a temperature of between about 100° C. to about 1° C. below a melting point of the crosslinked polymeric material at the applied pressure, and then the material is further heated above the temperature, but below a melting point of the crosslinked polymeric material at the applied pressure.

In some embodiments, the annealing includes heating a crosslinked polymeric material to a temperature that is about 25° C. to about 0.5° C. below a melting point of the crosslinked polymeric material, and then applying pressure above nominal atmospheric pressure.

Various other annealing methods are described in U.S. patent application Ser. No. 11/359,845, filed on Feb. 21, 2006, which is incorporated herein by reference in its entirety.

Annealing of any polymeric material described herein can be performed by applying microwave radiation to the material. In some embodiments, the polymeric material includes a microwave radiation-active material that aids in the heating of the polymeric material.

### Manufacture of Preforms

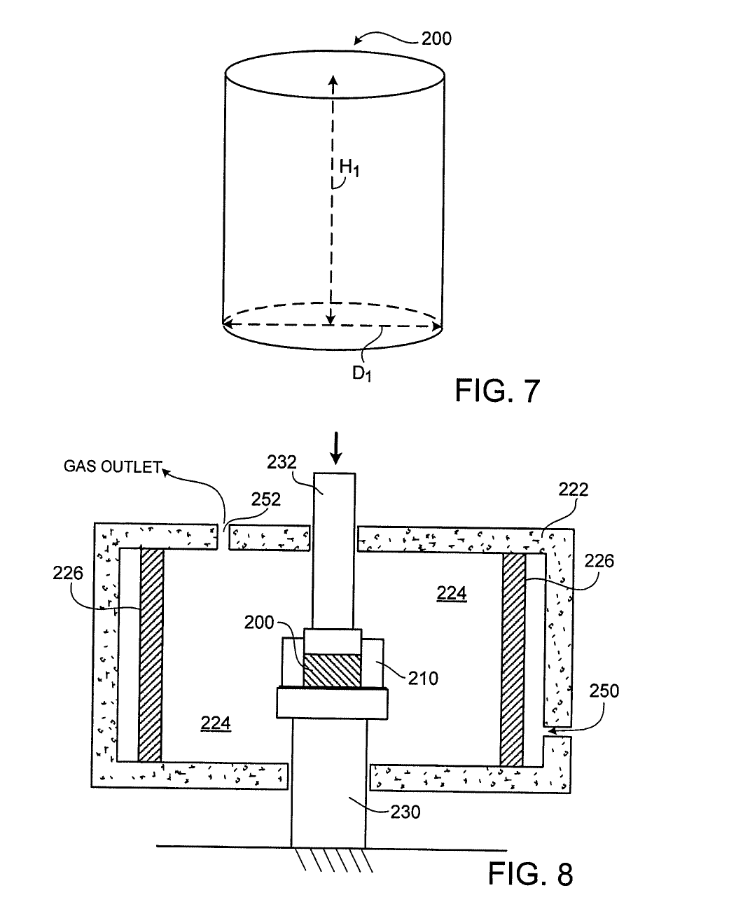

Referring now to FIGS. 7 and 8, in particular embodiments, to make a crosslinked UHMWPE cylindrical preform that is resistant to oxidation, a substantially non-crosslinked cylindrical preform 200 is obtained, e.g., by machining rod stock to a desired height H₁ and desired diameter D₁. Preform 200 can be made from a substantially non-crosslinked UHMWPE having a melting point of around 138° C., and a degree of crystallinity of about 52.0 percent. This crystallinity is either reduced, e.g., by heating the preform 200 above the melting point of the UHMWPE, and then cooling, or the crystallinity is maintained, but not increased. Preform 200 is then subjected to gamma radiation, e.g., 50 kGr (5 Mrad; 1 Mrad=10 KGr) of gamma radiation, to crosslink the UHMWPE. After irradiation, the sample is press-fit into a pressure cell 210, and then the pressure cell 210 is placed into a furnace assembly 220. Furnace assembly 220 includes an insulated enclosure structure 222 that defines an interior cavity 224. Insulated enclosure structure 222 houses heating elements 224 and the pressure cell 210, e.g., that is made stainless steel, and that is positioned between a stationary pedestal 230 and a movable ram 232.

The crosslinked UHMWPE sample is first heated to a temperature Temp₁ below the melting point of the UHMWPE, e.g., 130° C., without the application of any pressure above nominal atmospheric pressure. After such heating, pressure P, e.g., 500 MPa of pressure, is applied to the sample, while maintaining the temperature Temp₁. Once pressurization has stabilized, the sample is further heated to a temperature Temp₂, e.g., 160° C., 180° C., 200° C., 220° C., or 240° C., while maintaining the pressure P. As noted, pressure is applied along a single axis by movable ram 232, as indicated by arrow 240. Pressure at the given temperature Temp₂ is generally applied for 10 minutes to 1 hour. During any heating, a gas such as an inert gas, e.g., nitrogen or argon, can be delivered to interior cavity 224 of insulated enclosure structure 222 through an inlet 250 that is defined in a wall of the enclosure structure 222. The gas exits through an outlet 252 that is defined in a wall of the enclosure structure, which maintains a pressure in the cavity 224 of about nominal atmospheric pressure. After heating to Temp₂ and maintaining the pressure P, the sample is allowed to cool to room temperature, while maintaining the pressure P, and then the pressure is finally released. The pressure cell 210 is removed from furnace 220, and then the oxidation resistant UHMWPE is removed from pressure cell 210.

Using the methods illustrated in FIGS. 3-6, by starting with an UHMWPE having a melting point of around 138° C., and a degree of crystallinity of about 52.0 percent, and using a temperature of Temp₂ of about 240° C., and a pressure P of about 500 MPa, one can obtain an oxidation resistant crosslinked UHMWPE that has a melting point greater than about 141° C., e.g., greater than 142° C., 143° C., 144° C., 145° C., or even greater than 146° C., and a degree of crystallinity of greater than about 52 percent, e.g., greater than 53, 54, 55, 56, 57, 58, 59, 60, 65, or even greater than 68 percent. In some embodiments, the crosslinked UHMWPE has a crosslink density of greater than about 100 mol/m³, e.g., greater than 200 mol/m³, 300 mol/m³, 400 mol/m³, 500 mol/m³, 750 mol/m³, or even greater than 1,000 mol/m³, and/or a molecular weight between crosslinks of less than about 9,000 g/mol, e.g., less than 8,000 g/mol, 7,000 g/mol, 6,000 g/mol, 5,000 g/mol, or even less than about 3,000 g/mol.

### Quenching Materials

A “quenching material” refers to a gas or a liquid, or a mixture of gases and/or liquids (at room temperature) that contain gaseous and/or liquid component(s) that can react with residual free radicals and/or radial cations to assist in the recombination of the residual free radicals and/or radical cations. The gas can be, e.g., acetylene, chloro-trifluoro ethylene (CTFE), ethylene, or other unsaturated compound. The gases or the mixtures of gases may also contain noble gases such as nitrogen, argon, neon, and the like. Other gases such as carbon dioxide or carbon monoxide may also be present in the mixture. In applications where the surface of a treated material is machined away during the device manufacture, the gas blend could also contain oxidizing gases such as oxygen. The quenching material can be one or more dienes, e.g., each with a different number of carbons, or mixtures of liquids and/or gases thereof. An example of a quenching liquid is octadiene or other dienes, which can be mixed with other quenching liquids and/or non-quenching liquids, such as a hexane or a heptane.

Quenching material can be applied to any polymeric material utilized in any step described herein.

### Antioxidants

Generally, because many of the materials will be used in medical devices, some even for permanent implantation, useful antioxidants are typically either Generally Recognized as Safe direct food additives (GRAS) in Section 21 of the Code of Federal Regulations or are EAFUS-listed, i.e., included on the Food and Drug Administration's list of “everything added to food in the United States.” Other useful antioxidants can also be those that could be so listed, or those that are classified as suitable for direct or indirect food contact. Examples of antioxidants that can be used in any of the methods described herein include, alpha- and delta-tocopherol; propyl, octyl, or dodecyl gallates; lactic, citric, and tartaric acids and salts thereof; as well as orthophosphates. In some instances, a preferable antioxidant is vitamin E. Still other food-grade antioxidants are available from Eastman under the tradename TENOX® (e.g., tertiary butylhydroquinone (TBHQ), propyl gallate (PG), butylated hydroxyanisole (BHA) and/or butylated hydroxytoluene (BHT)). For example other antioxidants include tertiary-butylhydroquinone (TBHQ), butylated hydroxyanisole (BHA), butylated hydroxytoluene (BHT), or mixtures of any of these or the prior-mentioned antioxidants.

In some embodiments, the antioxidant has a melting point above about 50° C., e.g., above about 100° C., above about 150° C., or above about 175° C. Since in the solid state the antioxidants can have less mobility in a polymeric matrix, controlling the melting point of the antioxidant can be a way of controlling the activity of the antioxidant.

### Microwave Radiation Active Materials

Any of the polymeric materials described herein can include microwave radiation-active materials, which can aid in the heating of the polymeric materials in any step described herein. Generally, microwave radiation-active materials are those that include a permanent dipole. For example, the microwave radiation-active materials can be inorganic materials, such as ceramics (e.g., carbides, borides, and nitrides), metals and metal alloys, quantum dots, or organic materials, such as edible oils or solids, e.g., sunflower oils, corn oils, wheat germ oils, vitamin E, fatty acids, alcohols, such as ethanol, n-propanol, isopropanol and n-butanol, water, or mixtures of any of these.

### Applications

The oxidation resistant crosslinked polymeric materials can be used in any application for which oxidation resistance, long-term stability, high wear resistance, low coefficient of friction, chemical/biological resistance, fatigue and crack propagation resistance, and/or enhanced creep resistance are desirable. For example, the oxidation resistant crosslinked polymeric materials are well suited for medical devices. For example, the oxidation resistant crosslinked polymeric material can be used as an acetabular liner, a finger joint component, an ankle joint component, an elbow joint component, a wrist joint component, a toe joint component, a hip replacement component, a tibial knee insert, an intervertebral disc, a heart valve, a stent, or part of a vascular graft.

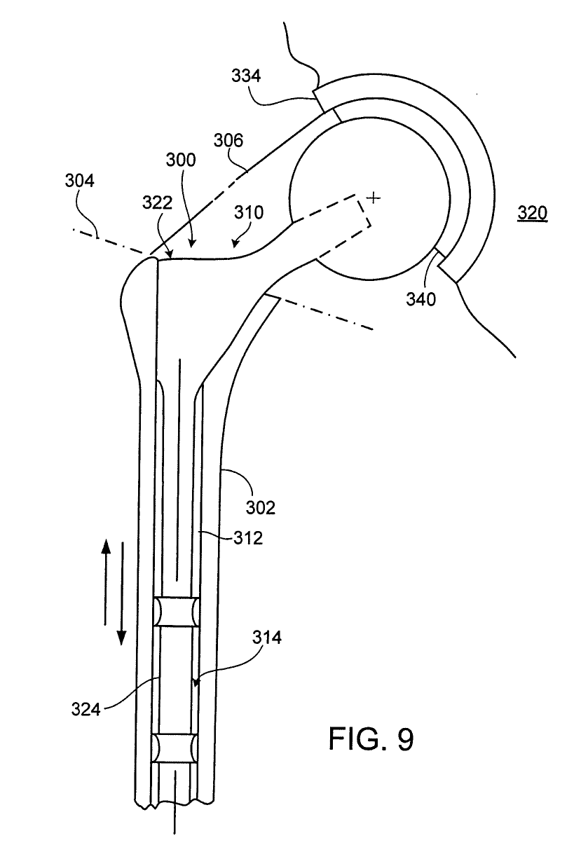

In a particular embodiment, the oxidation resistant crosslinked polymeric material is used as a liner in a hip replacement prostheses. Referring to FIG. 9, joint prosthesis 300, e.g., for treatment of osteoarthritis, is positioned in a femor 302, which has been resected along line 304, relieving the epiphysis 306 from the femur 302. Prosthesis 300 is implanted in the femur 302 by positioning the prosthesis in a cavity 310 formed in a portion of cancellous bone 312 within medullary canal 314 of the femur 302. Prosthesis 300 is utilized for articulating support between femur 302, and acetabulum 320. Prosthesis 300 includes a stem component 322, which includes a distal portion 324 disposed within cavity 310 of femur 302. Prosthesis 300 also includes a cup 334, which is connected to the acetabulum 320. A liner 340 is positioned between the cup 334 and the stem 322. Liner 44 is made of the oxidation resistant crosslinked polymeric material described herein.

### Examples

The invention is further described in the following examples, which do not limit the scope of the invention described in the claims.

### Example 1

GUR 1050 grade ultrahigh molecular weight polyethylene (UHMWPE) rod stock of 1 inch diameter was sliced into cylinders of approximately 1 inch in height (H₁′). The cut rod stock was placed in a Carver hydraulic press, and heated to 150° C. using heating platens. After complete melting, the temperature was decreased to 130° C. At this temperature, UHMWPE generally takes several days to fully crystallize, and therefore remains in the melted state during experimentation. These samples were then compressed to various compression ratios (CR), which led to a decrease in the final height (H₂′) of the samples. The samples were cooled to room temperature, and then placed in a convection oven at 148° C. until all the samples completely melted. During this time, there was strain recovery and the height of the samples increased to a final height (H₃′), since the samples were left unconstrained in the oven. The samples did not fully recover in that (H₃′) was always less than (H₁′), as shown in Table 1 below.

TABLE 1
Initial height (H₁′), height after compression (H₂′),
compression ratio (CR₁), height after melting (H₃′),
and final residual compression ratio (CR₂) for samples of
Example 1. All heights expressed in millimeters (mm).

| H₁′ | H₂′ | CR₁ = H₁′/H₂′ | H₃′ | CR2 = H₁′/H₃′ |
|---|---|---|---|---|
| 26.4 | 4.00 | 6.6 | 16.9 | 1.56 |
| 26.2 | 3.40 | 7.7 | 16.8 | 1.56 |
| 27.9 | 2.54 | 11 | 17.4 | 1.60 |
| 29.3 | 2.25 | 13 | 16.4 | 1.79 |

### Example 2

GUR 1050 grade UHMWPE rod stock of 3 inch in diameter was gamma radiation crosslinked using a 50 kGy dose. Each rod was sliced into cylinders of 1 inch high, placed in a Carver hydraulic press, heated to 150° C., and compressed to compression ratios of 1.23, 1.50 and 1.86. Further compression to 2.0 led to catastrophic failure, probably due to the limit of extensibility of 50 kGy crosslinked polyethylene in the melt state. Thereafter, each sample was placed in a convection oven and melted at 150° C. until the samples completely melted (over a period of approximately 1 hour). Sample heights were measured after strain recovery. All samples completely recovered to their original height.

### Example 3

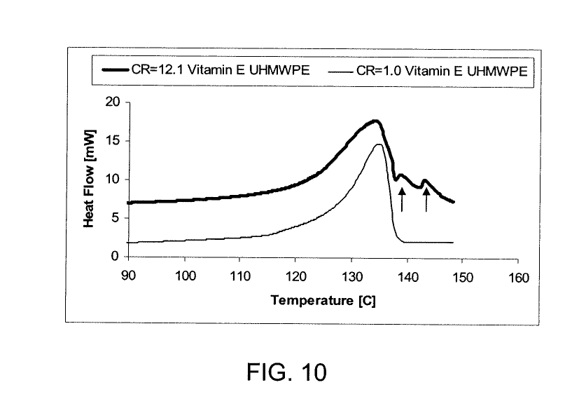

A compression molded sheet (Meditech Medical Polymers, Fort Wayne, Ind.) of GUR 1020 (Ticona, Bayport, Tex.) ultra-high molecular weight polyethylene (UHMWPE) containing 0.05% by weight alpha-tocopherol was sectioned into a rectangular block of 31.5 mm height. The block was heated to 180° C. between pre-heated platens of a Carver Hydraulic Press. After complete melting of the sample, the sample temperature was decreased to 136° C. At this temperature, the UHMWPE remained substantially amorphous since the melting temperature of the uncompressed control was 134.8° C. The sample was uniaxially compressed at 136° C. to a compression ratio (CR), defined by the ratio of initial height to final height, of 12.1 and then rapidly cooled using circulating water to room temperature, followed by release of load. During compression, the transparent, melted sample became translucent, indicating strain-induced crystallization had occurred at a large compression ratio. The crystallinity and melting temperature of the compressed sample and control were measured using a Perkin Elmer Diamond differential scanning calorimeter (DSC). A heating scan rate of 10° C./min was used until a temperature of 155° C., well above the highest melting temperature for polyethylene. Samples of approximately 5 mg in weight were sectioned from the interior regions of the compressed specimen. Percentage crystallinity was obtained as Xc=100*δH/δH_{f}, where δH is the area under the endotherm and δH_{f} is the heat of fusion of PE (293 J/g). FIG. 10 shows that the melt-compressed UHMWPE containing Vitamin E had two additional melting peaks at 139° C. and 143.6° C., associated with extended-chain crystals which form due to strain-induced crystallization and which appear at a melting temperature higher than 140° C. during the DSC scan.

The piece of the specimen with a compression ratio of 12.1 was annealed at 130° C. for a period of 1 hour to allow for strain recovery and then annealed at 115° C. for 24 hours. There was limited strain recovery, because most of the sample was expected to relax during cooling from the melt state. The final compression ratio after strain recovery was 11.0. The article was then irradiated using 2.8 MeV electron beam irradiation to a dose of 100 kGy. No heat treatment was performed after irradiation to remove free radicals since there was Vitamin E present in the sample. Thus, this annealed article was highly-crosslinked, oxidation-resistant, and had low anisotropy due to the strain recovery compared to the article prior to annealing. The annealed article had about the same number of free radicals as the article prior to annealing since it had no further heat treatment like the aforementioned article and contained extended chain crystals with a melting temperature higher than 140° C.

### Example 4

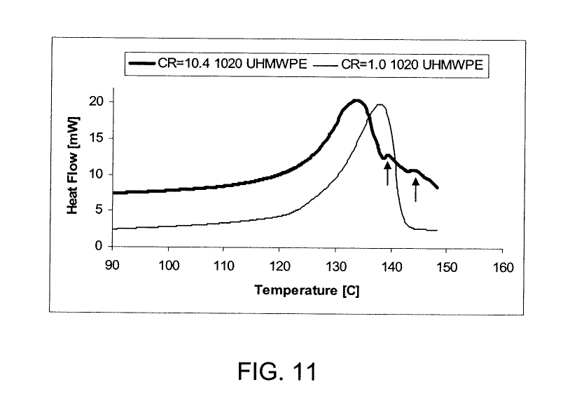

A compression molded sheet (Meditech Medical Polymers, Fort Wayne, Ind.) of GUR 1020 (Ticona, Bayport, Tex.) ultra-high molecular weight polyethylene (UHMWPE) was sectioned into a rectangular block of 31.2 mm height. The block was heated to 150° C. between pre-heated platens of a Carver Hydraulic Press. After complete melting of the sample, the sample temperature was decreased to 140° C. At this temperature, the UHMWPE remains substantially amorphous since the melting temperature of control UHMWPE was 137.9° C. The sample was uniaxially compressed at 140° C. to a compression ratio of 10.9 and then rapidly cooled using circulating water to room temperature, followed by release of load. During compression, the transparent, melted sample became translucent, indicating strain-induced crystallization had occurred at a large compression ratio. The crystallinity and melting temperature of the compressed sample and control were measured using DSC, as explained in Example 3. FIG. 11 and Table 2 show that the melt-compressed UHMWPE had two additional melting peaks, associated with extended-chain crystals, which form due to strain-induced crystallization and which appear at a melting temperature of 139° C. and 145.9° C. during the DSC scan.

The sample was then annealed at 130° C. in a convection oven under nitrogen atmosphere for 1 hour and then annealed at 115° C. for a period of 24 hours. The sample was then irradiated at room temperature using 2.8 MeV electron beam irradiation to a dose of 100 kGy. The sample was again annealed at 130° C. after irradiation to allow for more strain recovery to make the sample less anisotropic and to simultaneously also decrease free radicals. Thus, this article was highly-crosslinked, oxidation-resistant, had low anisotropy compared to the article prior to annealing, had less free radicals compared to the article prior to annealing and contained extended chain crystals with a melting temperature higher than 140° C.

TABLE 2
Crystallinity (Xc) and melting temperatures (Tm) for GUR 1020
UHMWPE and GUR 1020 UHMWPE containing 0.05% Vitamin
E compressed in the melt-state at various temperatures to
various compression ratios (CR).

| | | | Additional |
|---|---|---|---|
| Sample ID | Xc [%] | Tm [C.] | Tm [C.] |
| UHMWPE, CR = 1.0 (Control) | 51.2 | 137.9 | None |
| UHMWPE CR = 10.4 @ 140 C. | 39.2 | 132.1 | 139.0, 145.9 |
| Vit E UHMWPE, CR = 1.0 (Control) | 46.4 | 134.8 | None |
| Vit E UHMWPE CR = 12.1 @ 136 C. | 46.8 | 134.1 | 139.0, 143.6 |
| Vit E UHMWPE CR = 12.2 @ 138 C. | 44.5 | 133.8 | 139.4, 144.0 |

### Example 5

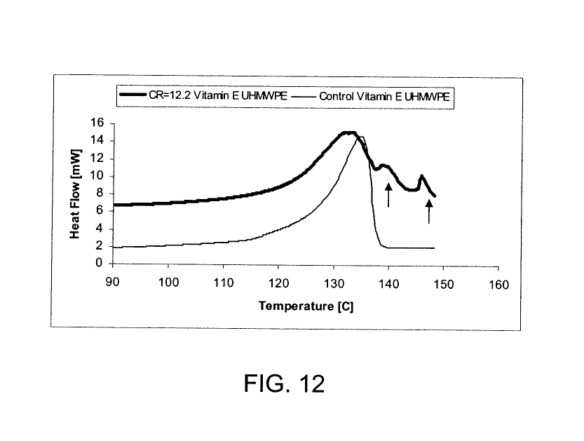

A compression molded sheet (Meditech Medical Polymers, Fort Wayne, Ind.) of GUR 1020 (Ticona, Bayport, Tex.) ultra-high molecular weight polyethylene (UHMWPE) containing 0.05% by weight alpha-tocopherol was sectioned into a rectangular block of 31.5mm height. The block was heated to 160° C. between pre-heated platens of a Carver Hydraulic Press. After complete melting of the sample, the sample temperature was decreased to 138° C. At this temperature, the UHMWPE remains substantially amorphous since the melting temperature of the uncompressed control was 134.8° C. The sample was uniaxially compressed at 138° C. to a compression ratio of 12.2 and then rapidly cooled using circulating water to room temperature, followed by release of load. During compression, the transparent, melted sample became translucent, indicating strain-induced crystallization had occurred at a large compression ratio. The crystallinity and melting temperature of the compressed sample and control were measured using DSC as described in Example 3. FIG. 12 and Table 2 show that the melt-compressed UHMWPE containing Vitamin E had two additional melting peaks at 139.4° C. and 144.0° C., associated with extended-chain crystals which formed due to strain-induced crystallization and which appeared at a melting temperature higher than 140° C. during the DSC scan.

The sample was annealed for 130° C. for a period of 1 hour to allow for strain recovery and then annealed at 115° C. for 24 hours. There was limited strain recovery with a final compression ratio after strain recovery of 10.9. The article was then irradiated at room temperature using 2.8 MeV electron beam irradiation to a dose of 100 kGy. No heat treatment was performed after irradiation to remove free radicals since there was Vitamin E present in the sample. Thus, this article was highly-crosslinked, oxidation-resistant, had low anisotropy due to the strain recovery, had free radicals since it had no further heat treatment, and contained extended chain crystals with a melting temperature higher than 140° C.

### Examples 6-9

A compression molded sheet (Meditech Medical Polymers, Fort Wayne, Ind.) of GUR 1020 (Ticona, Bayport, Tex.) ultra-high molecular weight polyethylene (UHMWPE) containing 0.05% by weight alpha-tocopherol was sectioned into a rectangular block of 31.5 mm height. The block was heated to 160° C. between pre-heated platens of a Carver Hydraulic Press. After complete melting of the sample, the sample temperature was decreased to 140.5° C. At this temperature, the UHMWPE remains substantially amorphous since the melting temperature of the uncompressed control was 134.8° C. The sample was uniaxially compressed at 140.5° C. to a compression ratio of 10.9 and then rapidly cooled using circulating water to room temperature, followed by release of load. During compression, the transparent, melted sample became translucent, indicating strain-induced crystallization had occurred at a large compression ratio. The sheet was sectioned into several pieces.

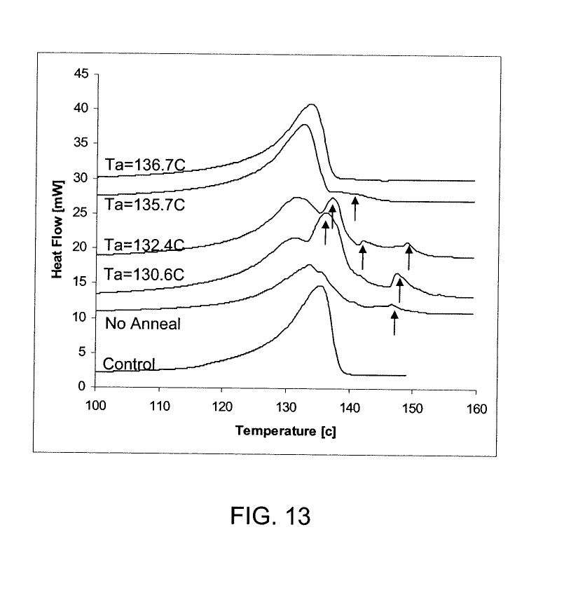

The followed groups were studied: 1) uncompressed control, 2) no annealing after compression 3) post-compression annealing at 130.6° C. for 24 h, 4) post-compression annealing at 132.4° C. for 24 h, 5) post-compression annealing at 135.7 C for 24 h and 6) post-compression annealing at 136.7° C. for 24 h. The crystallinity and melting temperature of the compressed sample and control were measured using DSC as described in Example 3. FIG. 13 and Table 3 show that the melt-compressed UHMWPE containing Vitamin E had higher order melting peaks, associated with extended-chain crystals which form due to strain-induced crystallization and which appear at a melting temperature higher than 140° C. during the DSC scan. Annealing up to 135° C. retained the higher-order melting peaks but annealing at 137° C. for 24 hours led to melting of the higher-order peaks. The sheets, uniaxially compressed to a compression ratio of 10.9 with no annealing, annealing at 130.6° C., 132.4° C., 135.7° C. and 136.7° C. were irradiated at room temperature to 100 kGy dose using 2.8 MeV electron beam irradiation. No post-irradiation thermal treatment was performed since each sample contained Vitamin E antioxidant and did not require thermal treatment to remove free radicals. These last four samples (Examples 6-9) were all highly crosslinked, oxidation resistant, contained similar concentration free radicals, and contained extended chain crystals with the exception of the sheet annealed at 136.7° C. for 24 h, and were expected to have lower and lower anisotropy with increasing annealing temperature for the same duration compared to the sample which was not annealed for strain recovery.

TABLE 3
Crystallinity (Xc) and melting temperatures (Tm) for GUR 1020
UHMWPE containing 0.05% Vitamin E uncompressed control,
compressed in the melt-state to a compression ratio of 10.9 at
140.5° C. without annealing and isothermal annealing for
24 hours at temperatures (Ta) of 131° C., 133° C.,
135° C. and 137° C., respectively.

| | Xc | Tm | |
|---|---|---|---|
| Sample ID | [%] | [C.] | Additional Tm [C.] |
| Vit E UHMWPE, CR = 1.0 (Control) | 46.4 | 134.8 | None |
| CR = 10.9, No anneal | 50.1 | 135.2 | 147.1 |
| CR = 10.9, Ta = 130.6 C. | 49.4 | 131.6 | 135.8, 148. |
| CR = 10.9, Ta = 132.4 C. | 51.3 | 132.4 | 142, 149 |
| CR = 10.9, Ta = 135.7 C. | 44.7 | 132.6 | 141 (broad peak) |
| CR = 10.9, Ta = 136.7 C. | 45.4 | 133.6 | None |

### Example 10

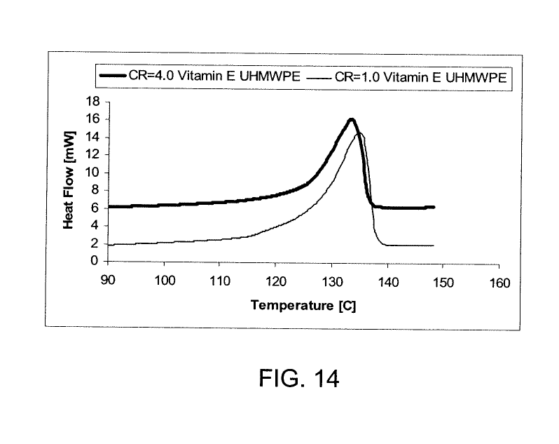

A compression molded sheet (Meditech Medical Polymers, Fort Wayne, Ind.) of GUR 1020 (Ticona, Bayport, Tex.) ultra-high molecular weight polyethylene (UHMWPE) containing 0.05% by weight alpha-tocopherol was sectioned into a rectangular block of 31.5 mm height. The block was slowly heated to 122° C. between pre-heated platens of a Carver Hydraulic Press. At this temperature, the UHMWPE remains substantially in the solid-state since the melting temperature of the uncompressed control was 134.8° C. The sample was uniaxially compressed at 122° C. to a compression ratio of 4.0 and then rapidly cooled using circulating water to room temperature, followed by release of load. During compression, the sample remained translucent throughout the deformation. The crystallinity and melting temperature of the compressed sample and control were measured using DSC as described in Example 3. FIG. 14 and Table 4 show that there were no higher-order peaks and the melting temperature and crystallinity did not change to a large extent. The sample was placed in a convection oven and heated to 130° C. for 1 hour for facilitate strain recovery and then at 115° C. for 24 hours. The final compression ratio was 2.3. The sample was then irradiated at room temperature to 100 kGy using 2.8 MeV electron beam radiation. This provided a highly crosslinked, oxidation resistant article with some residual strain, containing detectable free radicals.

TABLE 4
Crystallinity (Xc) and melting temperatures (Tm) for GUR 1020
UHMWPE and GUR 1020 UHMWPE containing 0.05%
Vitamin E compressed in the solid-state to a
compression ratio of 3.5 and 4.0 respectively

| | Xc | Tm | |
|---|---|---|---|
| Sample ID | [%] | [C.] | Additional Tm [C.] |
| UHMWPE, CR = 1.0 (Control) | 51.2 | 137.9 | None |
| UHMWPE CR = 3.5 @ 120 C. | 45.9 | 135.2 | None |
| Vit E UHMWPE, CR = 1.0 (Control) | 46.4 | 134.8 | None |
| Vit E UHMWPE CR = 4.0 @ 122 C. | 44.5 | 133.5 | None |

### Example 11

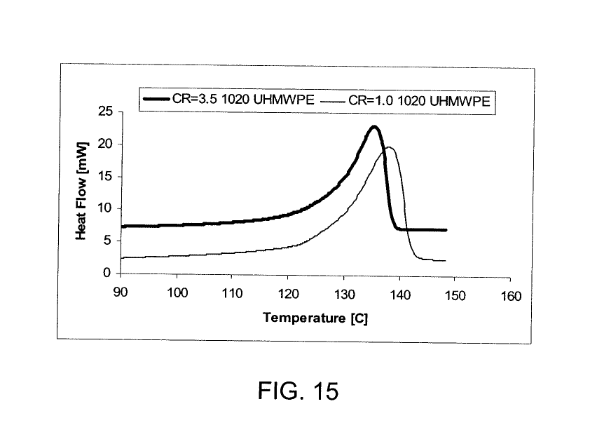

A compression molded sheet (Meditech Medical Polymers, Fort Wayne, Ind.) of GUR 1020 (Ticona, Bayport, Tex.) ultra-high molecular weight polyethylene (UHMWPE) was sectioned into a rectangular block of 31.5 mm height. The block was slowly heated to 120° C. between pre-heated platens of a Carver Hydraulic Press. At this temperature, the UHMWPE remains substantially in the solid-state since the melting temperature of the uncompressed control was 137.9° C. The sample was uniaxially compressed at 120° C. to a compression ratio of 3.5 and then rapidly cooled using circulating water to room temperature, followed by release of load. During compression, the sample remained translucent throughout the deformation. The crystallinity and melting temperature of the compressed sample and control were measured using DSC as described in Example 2. FIG. 15 and Table 4 show that there were no higher-order peaks and the melting temperature and crystallinity did not change to a large extent. The sample was placed in a convection oven and heated to 115° C. for 24 hours for partial strain recovery. The final compression ratio after heat treatment was 2.4. The sample was then irradiated at room temperature to 100 kGy using 2.8 MeV electron beam radiation. The sample was then placed in a convection oven and maintained at 130° C. for 24 hours to facilitate further strain recovery and to remove free radicals. The final compression ratio after this step was 1.97. This provided a highly crosslinked article with some residual strain, containing detectable but few free radicals.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method of making a crosslinked preform comprising a crosslinked polymeric material, the method comprising:
selecting a non-crosslinked preform having a first dimension and comprising a substantially non-crosslinked polymeric material;
elongating the non-crosslinked preform in a first direction of the substantially non-crosslinked polymeric material to provide an elongated preform having a second dimension larger than the first dimension, and comprising a substantially non-crosslinked, disentangled polymeric material;
fixing the elongated preform to provide a fixed, elongated preform comprising a fixed substantially non-crosslinked, disentangled polymeric material;
heating the fixed, elongated preform to a second temperature about or above a melting point of the fixed substantially non-crosslinked, disentangled polymeric material, to recover at least a portion of strain induced during elongating, and to provide a relaxed preform comprising a substantially non-crosslinked, relaxed polymeric material; and
crosslinking the substantially non-crosslinked, relaxed polymeric material of the relaxed preform to provide a crosslinked preform comprising a crosslinked polymeric material.

2. The method of claim 1, further comprising annealing the crosslinked preform.

3. The method of claim 2, wherein the annealing comprises heating the crosslinked preform to a temperature below a melting point of the crosslinked polymeric material.

4. The method of claim 3, wherein the temperature is above 100° C. below a melting point of the crosslinked polymeric material.

5. The method of claim 2, wherein the annealing comprises applying a pressure of greater than 10 MPa to the crosslinked polymeric material, while heating the crosslinked material to a temperature below a melting point of the crosslinked polymeric material at the applied pressure for a time sufficient to provide an oxidation resistant crosslinked polymeric material.

6. The method of claim 5, wherein the applied pressure is greater than 350 MPa.

7. The method of claim 2, wherein the annealing is carried out in the presence of a reactive gas that quenches residual reactive species trapped in the crosslinked polymeric material.

8. The method of claim 7, wherein the reactive gas comprises one or more unsaturated compounds.

9. The method of claim 8, wherein the unsaturated gas comprises acetylene.

10. The method of claim 1, wherein the non-crosslinked preform further comprises one or more molecules, each having a permanent dipole moment.

11. The method of claim 10, wherein the heating comprises exposing the fixed, elongated preform to microwave radiation.

12. The method of claim 2, wherein the crosslinked preform further comprises one or more molecules, each having a permanent dipole moment.

13. The method of claim 12, wherein the annealing comprises exposing the crosslinked preform to microwave radiation.

14. The method of claim 1, wherein the fixed, elongated preform is heated to a temperature less than about 3° C. below the melting point.

15. The method of claim 1, wherein the fixed, elongated preform is heated for a time of at most about 20 minutes.

16. The method of claim 1, wherein the crosslinked preform comprising the crosslinked polymeric material further comprises one or more antioxidants

17. The method of claim 16, wherein the antioxidant comprises one or more phenolic compounds.

18. The method of claim 17, wherein the one or more phenolic compounds comprise alpha-tocopherol.

19. The method of claim 1, wherein any one or both of the substantially non-crosslinked preform and the crosslinked preform are in the form of a medical device or portion thereof.

20. The method of claim 1, wherein the substantially non-crosslinked preform is in rod form having a longitudinal length, and wherein the first dimension is the longitudinal length of the substantially non-crosslinked preform.

21. The method of claim 1, wherein the substantially non-crosslinked preform is in sheet form having a length, a width, and a thickness, and wherein the first dimension is either the width or the length of the preform.

22. The method of claim 1, wherein during or after elongating the non-crosslinked preform in the first direction, the preform is further elongated in a second direction.

23. The method of claim 22, wherein the second direction is substantially perpendicular to the first direction.

24. The method of claim 1, wherein elongating the substantially non-crosslinked preform in the first direction is performed by stretching the substantially non-crosslinked preform in the first direction.

25. The method of claim 1, wherein elongating the substantially non-crosslinked preform in the first direction is performed by compressing the substantially non-crosslinked preform in a direction substantially perpendicular to the first direction.

26. The method of claim 1, wherein elongating the substantially non-crosslinked preform in the first direction is performed at a temperature of between 140° C. to about 180° C.

27. The method of claim 1, wherein elongating the substantially non-crosslinked preform is performed by uniaxial tensile stress, biaxial tensile stress, uniaxial compression, channel-die compression, shear stress, biaxial compression, or biaxial compression followed by elongation, or combinations thereof.

28. The method of claim 1, wherein the second dimension is between about 0.5 percent and 500 percent larger than the first dimension.

29. The method of claim 1, wherein the second dimension is between about 5 percent and 100 percent larger than the first dimension.

30. The method of claim 1, wherein the second dimension is between about 10 percent and 50 percent larger than the first dimension.

31. The method of claim 1, wherein fixing of the elongated preform results from stretching the elongated preform in a manner so as to increase a material melting point above a temperature at which the stretching is performed.

32. The method of claim 1, wherein during elongation, there is strain-induced crystallization.

33. The method of claim 1, wherein the fixing of the elongated preform comprises cooling the elongated preform below a material melting point.

34. The method of claim 1, wherein crosslinking is performed with ionizing radiation.

35. The method of claim 34, wherein the ionizing radiation is applied at a total dose of greater than 50 kGy.

36. The method of claim 34, wherein the ionizing radiation is applied at a dose rate of greater than 0.1 kGy/hour.

37. The method of claim 1, wherein crosslinking occurs below a melting point of the fixed substantially non-crosslinked, elongated polymeric material.

38. The method of claim 1, wherein the substantially non-crosslinked, disentangled material and the fixed substantially non-crosslinked, disentangled polymeric material each have a different crystallinity, a different melting point, or both.

39. The method of claim 1, wherein the substantially non-crosslinked polymeric material comprises as an ultra-high molecular weight polyethylene.

40. The method of claim 1, wherein the crosslinking occurs at about nominal atmospheric pressure.

41. The method of claim 1, further comprising elongating the non-crosslinked preform, fixing the elongated preform to provide a fixed, elongated preform, and heating the fixed, elongated preform one or more times to provide a relaxed preform prior to crosslinking.

42. A method of making a highly crosslinked preform comprising a highly crosslinked polymeric material, the method comprising:
selecting a non-crosslinked preform having a first dimension, and comprising a substantially non-crosslinked polymeric material;
crosslinking the substantially non-crosslinked polymeric material to provide a first crosslinked preform comprising a first crosslinked polymeric material having a first crosslink density of less than about 100 mol/m³;
elongating the first crosslinked preform in a first direction of the first crosslinked polymeric material to provide a crosslinked, elongated preform having a second dimension larger than the first dimension, and comprising a disentangled, crosslinked polymeric material;
fixing the crosslinked, elongated preform to provide a fixed, crosslinked preform comprising a fixed crosslinked, disentangled polymeric material;
heating the fixed, elongated preform to a second temperature at about or above a melting point of the fixed crosslinked, disentangled polymeric material to recover at least a portion of strain induced during elongating, and to provide a relaxed, crosslinked preform comprising a relaxed, crosslinked polymeric material; and
crosslinking the relaxed, crosslinked preform to provide a highly crosslinked preform comprising a highly crosslinked polymeric material having a second crosslink density greater than the first crosslink density.

43. The method of claim 42, wherein crosslinking of the substantially non-crosslinked polymeric material comprises exposing the non-crosslinked preform to a radiation dose of less than about 10 kGy.

44. The method of claim 42, wherein the second crosslink density is greater than about 150 mol/m³.

45. The method of claim 42, wherein crosslinking of the relaxed, crosslinked preform comprises exposing the relaxed, crosslinked preform to a radiation dose of greater than about 25 kGy.

46. The method of claim 42, wherein the first crosslinked preform has a molecular weight between crosslinks of greater than about 7,500 g/mol.

47. A method of making a highly crosslinked preform comprising a highly crosslinked polymeric material, the method comprising:
selecting a non-crosslinked preform having a first dimension and comprising a substantially non-crosslinked polymeric material;
crosslinking the substantially non-crosslinked polymeric material with a first radiation dose of less than about 75 kGy to provide a first crosslinked preform comprising a first crosslinked polymeric material having a first crosslink density;
elongating the first crosslinked preform in a first direction of the first crosslinked polymeric material to provide a crosslinked, elongated preform having a second dimension larger than the first dimension, and comprising a disentangled, crosslinked polymeric material;
fixing the crosslinked, elongated preform to provide a fixed, crosslinked preform comprising a fixed crosslinked, disentangled polymeric material;
heating the fixed, elongated preform to a second temperature at about or above a melting point of the fixed crosslinked, disentangled polymeric material to recover at least a portion of strain induced during elongating and to provide a relaxed, crosslinked preform comprising a relaxed, crosslinked polymeric material; and
crosslinking the relaxed, crosslinked preform with a second radiation dose greater than the first dose to provide a highly crosslinked preform comprising a highly crosslinked polymeric material having a second crosslink density greater than the first crosslink density.

48. The method of claim 47, wherein crosslinking the substantially non-crosslinked polymeric material, or crosslinking the relaxed, crosslinked preform, or both, are performed in the absence of oxygen.

49. The method of claim 47, wherein the substantially non-crosslinked polymeric material includes one or more antioxidants.
